(19) United States
(12) Patent Application Publication
(10) Pub. No.: US 2015/0172431 A1
(43) Pub. Date: Jun. 18, 2015

(54) MULTIFUNCTIONAL PROTECTIVE CASE FOR ELECTRONIC DEVICE

(71) Applicant: TRIANGUS GROUP CO., LTD., Taoyuan County (TW)

(72) Inventor: Kuo Shih HUANG, Taoyuan County (TW)

(73) Assignee: TRIANGUS GROUP CO., LTD., Taoyuan County (TW)

(21) Appl. No.: 14/260,524

(22) Filed: Apr. 24, 2014

(30) Foreign Application Priority Data
Dec. 13, 2013 (TW) 102223550
Mar. 17, 2014 (TW) 103204479

(51) Int. Cl. H04M 1/02; H04B 1/3883; H04B 1/3888

(52) U.S. Cl. CPC H04M 1/0283; H04B 1/3888; H04M 1/0272; H04B 1/3883; H04M 1/0264; A45C 2011/002

(57) ABSTRACT

A multifunctional protective case is configured for use with a hand-held electronic device and is assembled from a protective shell and a functional shell. The protective shell is normally fitted on the hand-held electronic device to protect the same against scratches and damages, and the functional shell is slidably and removably assembled to an outer side of the protective shell. The functional shell has a slide end portion for slidably connecting to the protective shell, and a fixing end portion for fixing to the hand-held electronic device or the protective shell. The functional shell is provided with an expansion structure that provides one or more functions. Functional shells with different expansion structures are exchangeable and can therefore be selectively assembled to the protective shell according to a user's actual need in use. Therefore, the protective case and the hand-held electronic device are more convenient and practical for use.

### FIELD OF THE INVENTION

The present invention relates to a protective case for use with a hand-held electronic device, such as a mobile phone, a tablet computer or the like; and more particularly to a multifunctional protective case for electronic device, the expanded function of which is quickly exchangeable to satisfy a user's different requirements.

### BACKGROUND OF THE INVENTION

With the constant progress in the electronic technological fields, various types of hand-held electronic devices have become very popular and been widely used by people in their daily life. The hand-held electronic devices can have differently designed configurations according to their intended functions. And, protective cases for various hand-held electronic devices are also available in the market. These protective cases show particular patterns and colors while provide some specific functions, making the protected hand-held electronic devices unique in appearance and function to attract more consumers, particularly young people.

The protective cases currently widely available in the market are usually integrally formed. Please refer to FIG. 1, which shows a conventional protective case 1 having a back plate 11 and a plurality of side walls 12 upward extended from outer edges of the back plate 11. The back plate 11 and the side walls 12 together define a receiving space 13 for correspondingly receiving a hand-held electronic device 14 therein.

When the protective case 1 is fitted onto the hand-held electronic device 14, the side walls 12 are tightly pressed against the peripheral surfaces of the hand-held electronic device 14 to thereby firmly hold the latter in the receiving space 13. In the case a user wants to replace the protective case, the user has to apply a certain degree of force to remove it from the hand-held electronic device 14. That is, the conventional protective case could not be conveniently replaced and the removal of it tends to produce scratches on the outer surfaces of the hand-held electronic device 14 or even cause damage to the latter, making the hand-held electronic device 14 inconvenient for use.

In addition, since the conventional protective case 1 is usually integrally formed, the patterns, colors and intended specific functions thereof all are directly provided on the back plate 11 and the side walls 12 of the protective case 1. That is, once the conventional protective case 1 is fitted onto the hand-held electronic device 14, the patterns, colors and functions thereof all are not exchangeable. When the user wants to change the patterns, colors and/or the functions of the protective case 1, the user has to buy another protective case for replacement. Therefore, the conventional protective case 1 for hand-held electronic device 14 is not convenient for use and fails to satisfy consumers' requirements for novel and unique products.

### SUMMARY OF THE INVENTION

A primary object of the present invention is to provide a multifunctional protective case that is assembled from two different parts. One of the parts is a protective shell serving as a protection layer normally fitted on the electronic device, and the other part is a functional shell having an expansion structure with one or more specific functions. Therefore, a user can, depending on actual need in use, select one functional shell that has an expansion structure with desired function or functions, and removably assemble the selected functional shell to the protective shell. And, the functional shell can be replaced with another one at any time to largely increase the functionality of the protective case.

Another object of the present invention is to provide a multifunctional protective case having a protective shell and a functional shell. The functional shell is slidably retained to the protective shell, enabling the two shells to be quickly assembled to or disassembled from each other. Thus, the multifunctional protective case of the present invention is more convenient and more practical for use.

To achieve the above and other objects, the multifunctional protective case provided according to the present invention is configured for use with a hand-held electronic device, and includes a protective shell for normally fitted on an exterior of the hand-held electronic device, and a functional shell for assembling to an outer side of the protective shell.

The protective shell includes a base having two opposite inner and outer sides, and a plurality of retaining sections upward extended from outer edges of the base, such that a locating space is defined between the base and the retaining sections for holding the hand-held electronic device therein. Further, the base further has a slideway and an auxiliary fixing rail formed thereon.

The functional shell adjoins the outer side of the base, and includes a slide end portion for detachably held to the protective shell and a fixing end portion for fixing to the hand-held electronic device or the protective shell. The functional shell is provided with at least one expansion structure that provides at least one specific function. The slide end portion has a slide block formed thereon for movably setting in the slideway on the base of the protective shell, and a guide block for setting in the auxiliary locating rail.

The slideway is configured as a through hole and includes a wider insetting section and a narrower limiting section. The slide block is upwardly set into the slideway via the insetting section and then moved into the limiting section. The limiting section is provided along two lateral edges thereof with two lengths of limiting projections while the slide block is provided along two lateral edges thereof with two lengths of limiting grooves for correspondingly engaging with the limiting projections, so as to limit the slide block to slide horizontally in the limiting section.

The protective shell includes at least one opening formed between the retaining sections, and the functional shell includes a cover plate formed at the fixing end portion corresponding to the opening. Further, the cover plate is provided with a connection element for connecting to the hand-held electronic device.

The present invention is characterized in that the protective shell is assembled to the functional shell through engagement with the slide end portion and the fixed end portion to form a completely assembled protective case; and that the slide end portion and the fixed end portion of the functional shell can be separated from the protective shell to form a disassembled protective case. Depending on actual need in use, a user can change the functional shell assembled to the protective shell to obtain different functions from the expansion structures on different functional shells.

The expansion structures according to different embodiments of the present invention can be differently configured to provided different functions.

According to a first embodiment, the expansion structure includes a magnetic connector electrically connected to the connection element. The magnetic connector includes an electric contact for contacting with and accordingly electrically connecting to a mating connector on an external transmission cable, and a plurality of magnetic elements located nearby the electric contact. The magnetic connector and the external transmission cable can be quickly connected to each other through magnetic attachment of the magnetic elements of the magnetic connector to corresponding magnetic elements on the external transmission cable.

According to a second embodiment, the expansion structure includes a slot electrically connected to the connection element for a memory card to insert therein; and the slot is indirectly electrically connected to the hand-held electronic device via the connection element.

According to a third embodiment, the expansion structure includes a transmission antenna embedded in the functional shell and electrically connected to the connection element. The transmission antenna is workable with an external sensor device to form a near field communication means.

According to a fourth embodiment, the expansion structure includes a micro-projector electrically connected to the connection element; and the micro-projector is indirectly electrically connected to the hand-held electronic device via the connection element and includes a projector lens located on a surface of the functional shell.

According to a fifth embodiment, the expansion structure includes a charging module. The charging module includes a power storage unit embedded in the functional shell, and a charging and discharging unit located on a surface of the fixing end portion and electrically connected to the power storage unit and the hand-held electronic device.

According to a sixth embodiment, the hand-held electronic device includes at least one speaker opening and a display screen, and the expansion structure includes at least one sound guide hole located on the cover plate. The sound guide hole has an end facing to and located adjacent to the speaker opening on the hand-held electronic device and another opposite end oriented in a direction the same as the display screen of the hand-held electronic device.

According to a seventh embodiment, the expansion structure includes a light source projector located on a surface of the functional shell, and an actuator also located on a surface of the functional shell and electrically connected to the light source projector.

According to an eighth embodiment, the expansion structure includes a light source projector located on a surface of the functional shell, an actuator also located on a surface of the functional shell and electrically connected to the light source projector, an algorithm module electrically connected to the light source projector, a display provided on a surface of the functional shell, and a reflected light receiver. The algorithm module is further electrically connected to the display and the reflected light receiver.

According to a ninth embodiment, the expansion structure includes a retaining slideway formed on a bottom surface of the functional shell, and a remote controller removably retained in the retaining slideway. The remote controller is externally provided with at least one control button and internally provided with a wireless transmission module; and the wireless transmission module is electrically connected to the control button and wirelessly communicable with the hand-held electronic device.

According to a variant of the ninth embodiment, the expansion structure includes a wireless transmission module embedded in the functional shell and at least one control button located on a surface of the functional shell; and the wireless transmission module is electrically connected to the control button and wirelessly communicable with the hand-held electronic device.

According to a tenth embodiment, the expansion structure includes at least one mounting rail for a wireless camera lens to mount thereto. The wireless camera lens is provided with at least one engaging block for correspondingly inserting into the mounting rail. In an operable embodiment, the expansion structure includes two curved mounting rails, which have a common center.

According to an eleventh embodiment, the expansion structure includes a wireless charging module. The wireless charging module includes a wireless charging receiver unit embedded in the functional shell and a connection terminal located on a surface of the fixing end portion of the functional shell. The wireless charging receiver unit receives a signal from an external wireless charging transmitter unit, and the connection terminal is electrically connected to the wireless charging receiver unit and the hand-held electronic device.

According to a twelfth embodiment, the expansion structure includes a stand structure connected to an outer side of the functional shell. The stand structure includes a coupling seat protruded from the outer side of the functional shell and a supporting arm coupled with the coupling seat.

The supporting arm is provided at an end with a suction cup for attaching to a smooth surface, and at another opposite end with a ball; and the coupling seat located on the functional shell includes a clamping socket corresponding to the ball. The ball is rotatably coupled with the clamping socket, allowing the functional shell and the supporting arm to swivel relative to each other.

The supporting arm includes a first connection bar and a second connection bar, which are rotatably connected end to end, so that an included angle between the first connection bar and the second connection bar is adjustable. The ball is located at an end of the first connection bar facing away from the second connection bar, and the suction cup is located at an end of the second connection bar facing away from the first connection bar.

The multifunctional protective case for electronic device according to the present invention is characterized in having a fixed protective shell and an exchangeable functional shell. Each functional shell has an expansion structure providing one or more specific functions. Through engagement of the slideway and the auxiliary fixing rail on the protective shell with the slide block and the guide block on the functional shell, the functional shell is quickly removably assembled to the protective shell, allowing a user to conveniently change the functional shell according to actual need in use. The protective shell is normally fitted onto a hand-held electronic device to protect the same against damage due to collision with an external object; the exchangeable functional shell allows the hand-held electronic device to have different expanded functions and become more practical and convenient for use. Therefore, the multifunctional protective case of the present invention has high added value.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the fitting of an electronic device into a conventional protective case;

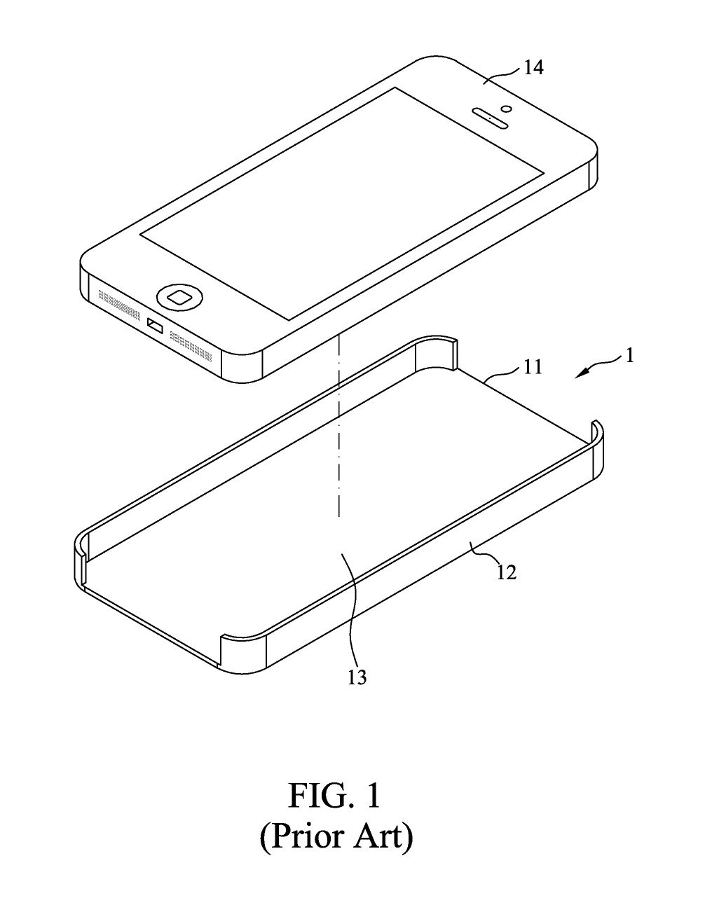

FIG. 2 is an exploded perspective view of a multifunctional protective case for electronic device according to a first preferred embodiment of the present invention;

FIG. 3 is a sectional view showing a protective shell and a functional shell of the multifunctional protective case according to the first preferred embodiment of the present invention in a separated state;

FIG. 4 shows the multifunctional protective case of the present invention with a first type of magnetic connector provided thereon;

FIG. 5 shows the multifunctional protective case of the present invention with a second type of magnetic connector provided thereon;

FIG. 6 shows the manner of assembling the functional shell to the protective shell;

FIG. 7 shows the manner of disassembling the functional shell from the protective shell;

FIG. 8 is an assembled perspective view of a multifunctional protective case for electronic device according to a second preferred embodiment of the present invention;

FIG. 9 is an assembled perspective view of a multifunctional protective case for electronic device according to a third preferred embodiment of the present invention;

FIG. 10 is an assembled perspective view of a multifunctional protective case for electronic device according to a fourth preferred embodiment of the present invention;

FIG. 11 shows the multifunctional protective case of FIG. 10 in use;

FIG. 12 is an exploded perspective view of a multifunctional protective case for electronic device according to a fifth preferred embodiment of the present invention;

FIG. 13 is an exploded perspective view of a multifunctional protective case for electronic device according to a sixth preferred embodiment of the present invention;

FIG. 14 is a perspective view of a functional shell of a multifunctional protective case for electronic device according to a seventh preferred embodiment of the present invention;

FIG. 15 shows the multifunctional protective case of FIG. 14 in use;

FIG. 16 is an assembled perspective view of a multifunctional protective case for electronic device according to an eighth preferred embodiment of the present invention;

FIG. 17 is a modular view of an expansion structure for the multifunctional protective case of FIG. 16;

FIG. 18 is an assembled perspective view of a multifunctional protective case for electronic device according to a ninth preferred embodiment of the present invention;

FIG. 19 shows the multifunctional protective case of FIG. 18 in use;

FIG. 20 shows a variant of the ninth preferred embodiment of the present invention;

FIG. 21 is an assembled perspective view of a multifunctional protective case for electronic device according to a tenth preferred embodiment of the present invention;

FIG. 22 shows the mounting of a wireless camera lens to the multifunctional protective case of FIG. 21;

FIG. 23 is an exploded perspective view of a multifunctional protective case for electronic device according to an eleventh preferred embodiment of the present invention;

FIG. 24 shows an application of the multifunctional protective case of FIG. 23;

FIG. 25 is an assembled perspective view of a multifunctional protective case for electronic device according to a twelfth preferred embodiment of the present invention, which includes an expansion structure configured as a stand structure;

FIG. 26 is an exploded view of the stand structure of FIG. 25;

FIG. 27 shows an operable embodiment of the multifunctional protective case of the present invention includes an expansion structure configured as a Bluetooth stereo device;

FIG. 28 shows another operable embodiment of the multifunctional protective case of the present invention includes an expansion structure configured as a earphone cord organizer; and

FIG. 29 shows a further operable embodiment of the multifunctional protective case of the present invention includes an expansion structure configured as an organizing device.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

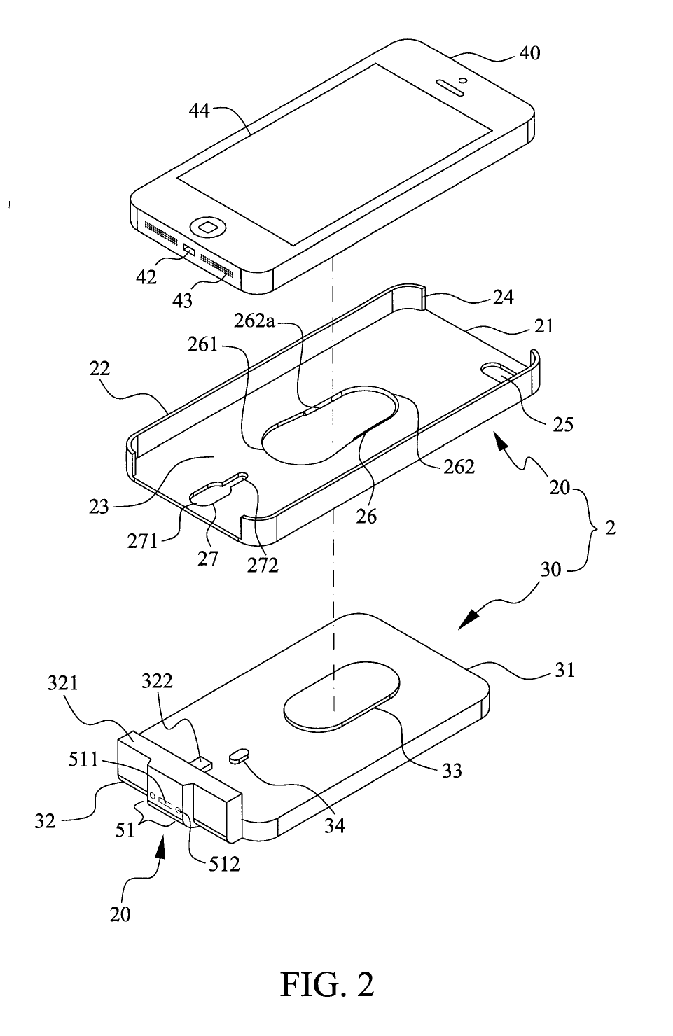

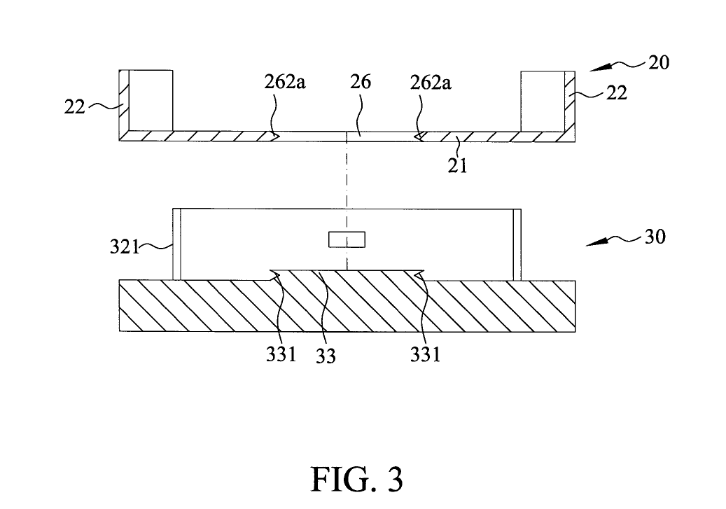

The present invention provides a multifunctional protective case for electronic device. For the purpose of conciseness and clarity, the present invention is also referred to as the multifunction protective case and generally denoted a reference numeral 2 herein. Please refer to FIGS. 2 and 3. The multifunctional protective case 2 according to a first preferred embodiment of the present invention includes a protective shell 20 and a functional shell 30, which are assembled together for fitting onto a hand-held electronic device 40.

The protective shell 20 includes a base 21 having two opposite inner and outer sides, and a plurality of retaining sections 22 upward extended from outer edges of the base 21, so that the base 21 and the retaining sections 22 together define between them a locating space 23 for tightly holding the hand-held electronic device 40 therein. In the illustrated first preferred embodiment, two retaining sections 22 are symmetrically formed to upward extend from a left and a right edge of the base 21; and two openings 24 are separately formed at a front and a rear edge of the base 21 to communicate with the locating space 23.

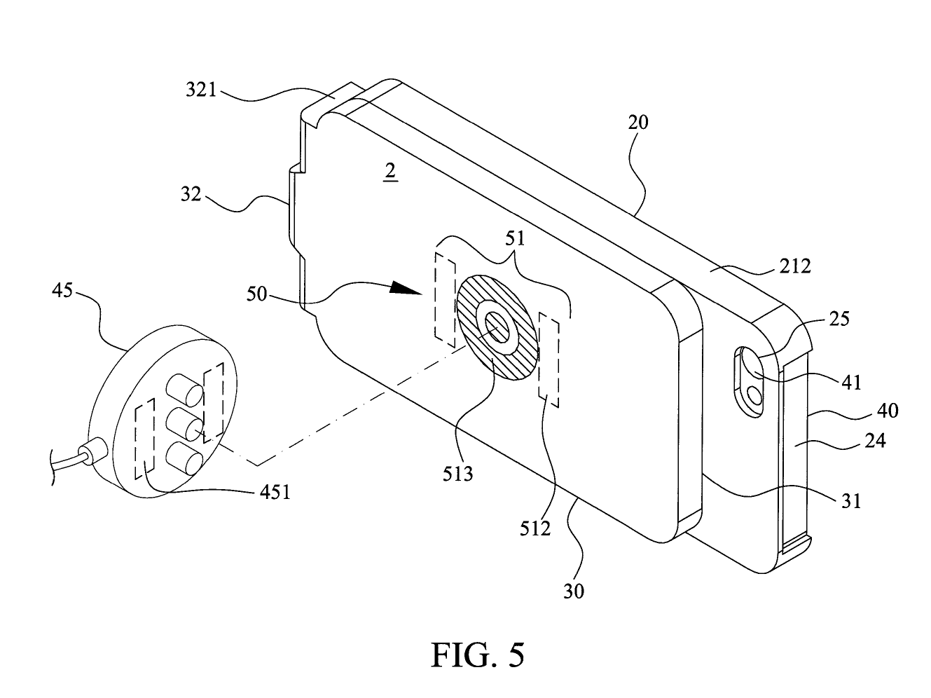

In the first preferred embodiment, the hand-held electronic device 40 to be protected by the multifunctional protective case 2 has a camera device 41 (see FIG. 5) provided on a bottom side thereof, and a transmission jack 42 provided at a rear end thereof. Two speaker openings 43 are also provided at the rear end of the hand-held electronic device 40 to separately locate at two lateral sides of the transmission jack 42. On a top side of the hand-held electronic device 40, which is located adjacent to the rear end with the speaker openings 43, there is provided a display screen 44.

On the base 21 near the front end thereof, a camera opening 25 is formed at a position corresponding to the camera device 41 on the hand-held electronic device 40, as can be seen in FIG. 5. And, a slideway 26 and an auxiliary locating rail 27 are formed on the base 21 along a central line thereof. The slideway 26 is configured as a through hole, and includes a wider insetting section 261 and a narrower limiting section 262. The limiting section 262 is provided along two lateral edges thereof with two lengths of limiting projections 262a. The auxiliary locating rail 27 is also in the form of a through hole, and has a wider insertion section 271 and a narrower locating section 272.

The functional shell 30 adjoins the outer side of the base 21, and includes a slide end portion 31 detachably held to the protective shell 20 and a fixing end portion 32 for fixing to the hand-held electronic device 40. On the slide end portion 31, there are provided a slide block 33 for setting in and linearly reciprocatingly moving in the slideway 26, and a guide block 34 for setting in and linearly reciprocatingly moving in the auxiliary locating rail 27. The slide block 33 is provided along two lateral edges thereof with two lengths of limiting grooves 331 for correspondingly engaging with the limiting projections 262a, so as to limit the slide block 33 to move horizontally in the limiting section 262 of the slideway 16.

The fixing end portion 32 has a rear edge extending outward to form a cover plate 321 for fully closing the opening 24 formed at the rear end of the protective shell 20. On the cover plate 321, there is provided a connection element 322 for plugging into the transmission jack 42 on the hand-held electronic device 40. The connection element 322 can serve as a coupling structure for holding the functional shell 30 to the hand-held electronic device 40, or an electric connector for electrically connecting to the hand-held electronic device 40.

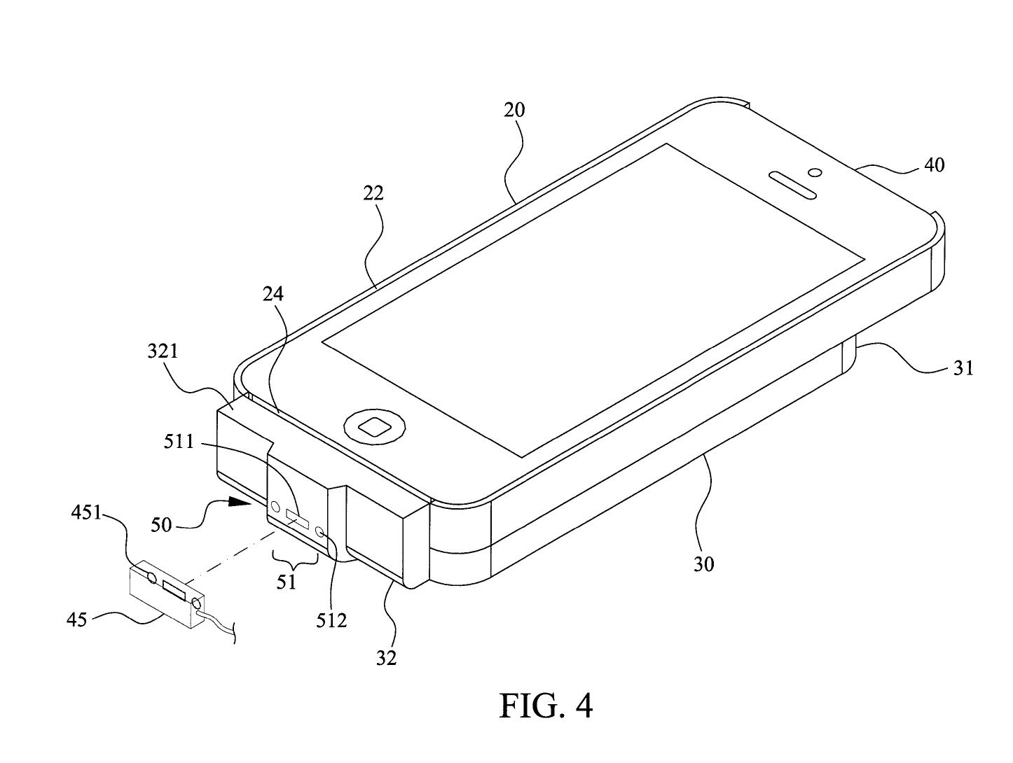

Please refer to FIG. 4. The functional shell 30 further includes an expansion structure 50. In the first preferred embodiment, the expansion structure 50 is configured as a magnetic connector 51 located on the cover plate 321 of the fixing end portion 32 and electrically connected to the connection element 322. The magnetic connector 51 includes an electric contact 511 for contacting with and accordingly electrically connecting to a mating connector on an external transmission cable 45, and a plurality of magnetic elements 512 located nearby the electric contact 511. When the magnetic elements 512 are magnetically attached to corresponding magnetic elements 451 on the external transmission cable 45, the external transmission cable 45 can be quickly connected to the functional shell 30.

Please refer to FIG. 5. The magnetic connector 51 can be otherwise configured to include an annular electric contact 513 and a plurality of magnetic elements 512 located nearby the annular electric contact 513. Correspondingly, the mating connector on the external transmission cable 45 can be in the form of a disc structure. Through a magnetic attraction of the magnetic elements 512 and the corresponding magnetic elements 451 to one another, the external transmission cable 45 can be firmly connected to an outer surface of the slide end portion 31.

It is understood the mating connector on the external transmission cable 45 in the form of a disc structure is only illustrative and not intended to limit the structure of the external transmission cable 45 in any way. For example, the external transmission cable 45 can include a mating connector in the form of a flat structure for magnetically attaching to the magnetic elements 512.

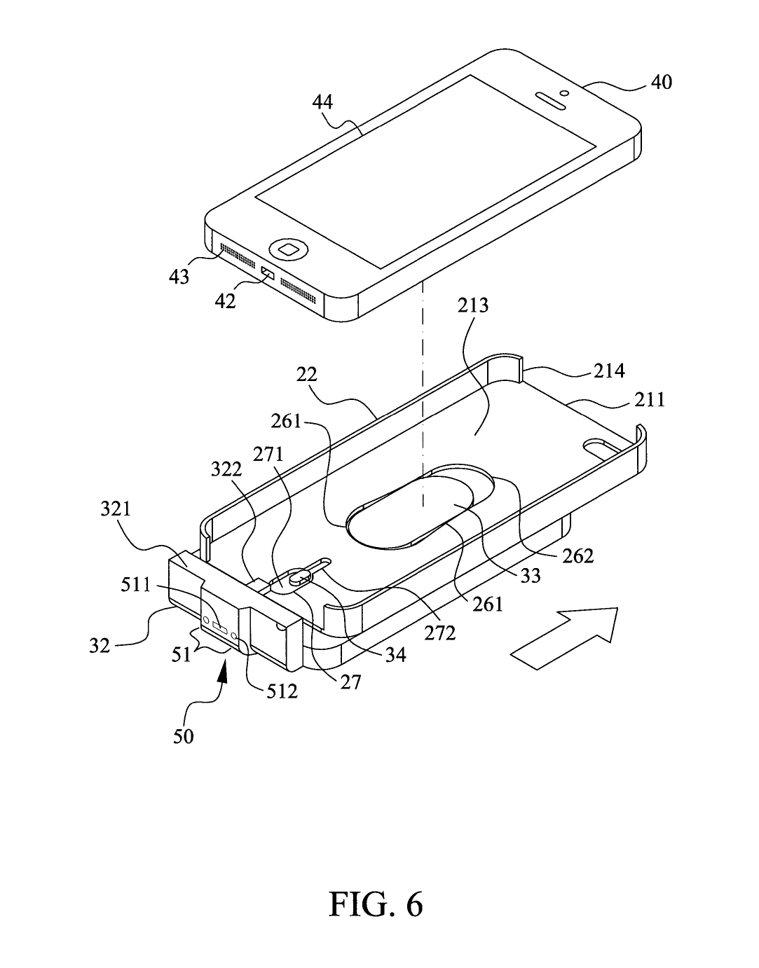

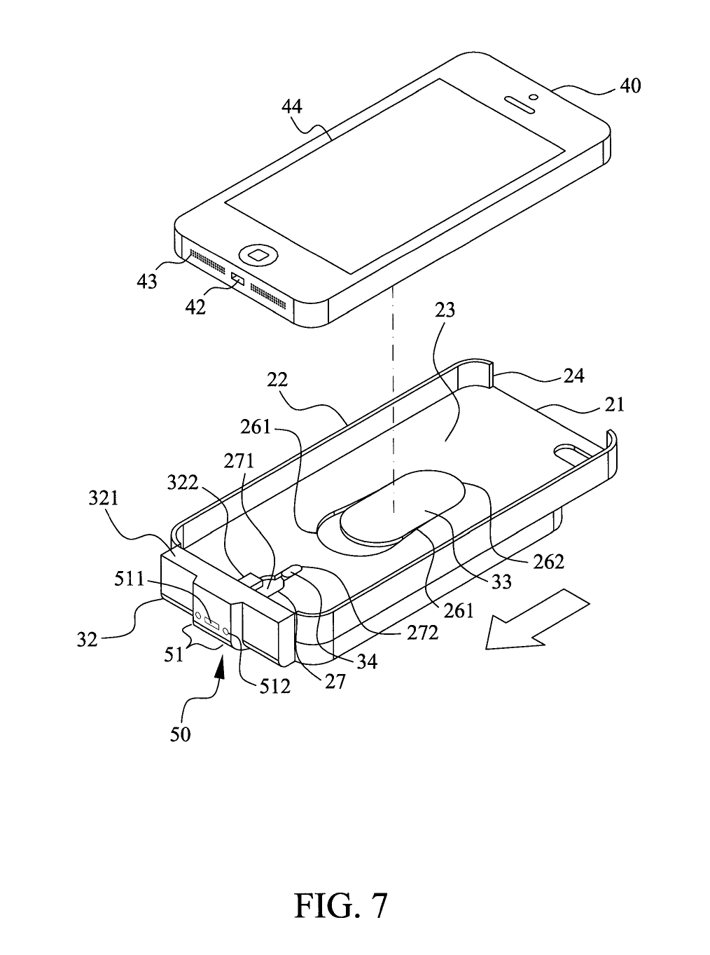

Please refer to FIGS. 6 and 7. The engagement of the slide block 33 with the slideway 26 defines a sliding path, only along which the functional shell 30 can slide relative to the protective shell 20. On the other hand, the engagement of the guide block 34 with the auxiliary locating rail 27 further ensures that the functional shell 30 can move stably along the defined sliding path.

As shown in FIG. 6, when a user wants to assemble the functional shell 30 to the protective shell 20, the user first upward sets the slide block 33 in the insetting section 261 of the slideway 26 and, at the same time, correspondingly upward sets the guide block 34 in the insertion section 271 of the auxiliary locating rail 27. Then, the user pushes the functional shell 30 in the arrow-indicated direction, so that the slide block 33 is moved into the limiting section 262 of the slideway 26 with the limiting projections 262a engaged with the limiting grooves 331, and the guide block 34 is moved into the locating section 272 of the auxiliary locating rail 27. Through the engagement of the slide block 33 with the limiting section 262 and the guide block 34 with the locating section 272, the functional shell 30 and the protective shell 20 are assembled together. With the protective shell 20 engaged with the slide end portion 31 and the fixing end portion 32 of the functional shell 30, the multifunctional protective case 2 of the present invention is in an assembled state.

When it is desired to use another functional shell 30 providing a different function, the user simply pushes the original functional shell 30 in a direction as indicated by the arrow in FIG. 7, so that the slide block 33 is moved from the limiting section 262 into the insetting section 261 of the slideway 26 and the guide block 34 is moved from the locating section 272 into the insertion section 271 of the auxiliary locating rail 27. At this point, the slide block 33 and the guide block 34 can be separated from the slideway 26 and the auxiliary locating rail 27, respectively, allowing the functional shell 30 to disassemble from the protective shell 20.

When the multifunctional protective case 2 of the present invention is in the assembled state and fitted onto the hand-held electronic device 40, the functional shell 30 and the protective shell 20 cooperatively prevent the hand-held electronic device 40 in use from being scratched or damaged by external foreign matters. Further, the functional shell 30 can have outer surfaces showing different colors or patterns, making the multifunctional protective case 2 of the present invention unique and more attractive to consumers.

Other preferred embodiments of the present invention will be described below. While these additional preferred embodiments respectively include a protective shell 20 and a functional shell 30 that are generally structurally similar to those in the first preferred embodiment, they do have their own unique expansion structure 50. Therefore, the following descriptions of the additional preferred embodiments are focused only on the expansion structures 50 thereof without repeating other identical structures.

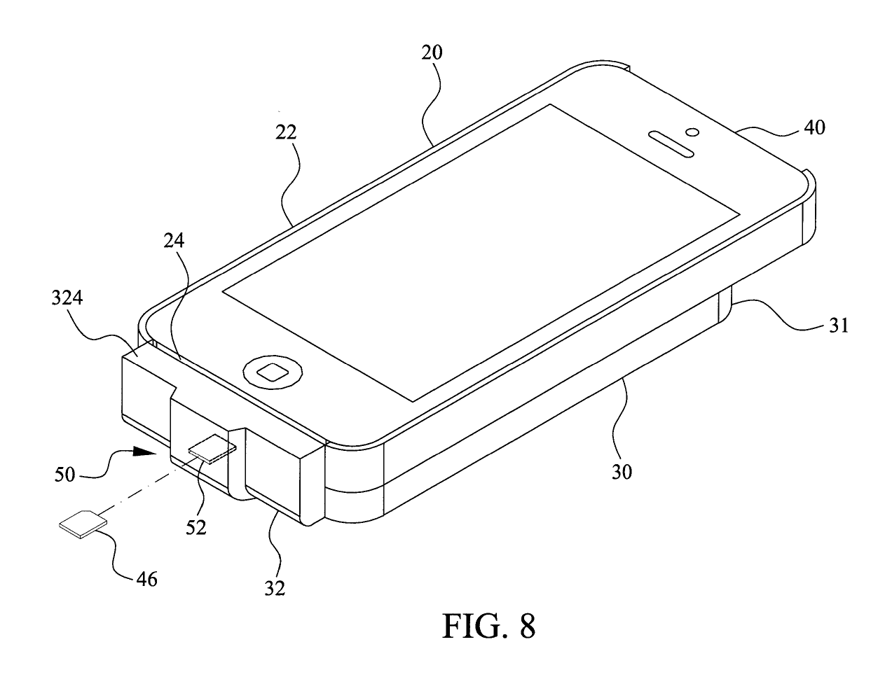

FIG. 8 shows the second preferred embodiment of the present invention, according to which the expansion structure 50 is a slot 52 electrically connected to the connection element 322. A memory card 46 can be inserted in the slot 52 to expand the storage space available in the hand-held electronic device 40, and the slot 52 can be indirectly electrically connected to the hand-held electronic device 40 via the connection element 322. In the illustrated second preferred embodiment, the slot 52 is located at a central position of the cover plate 321 at the fixing end portion 32 of the functional shell 30. However, it is understood the above location of the slot 52 is only illustrative and not intended to limit the present invention in any way. For example, the slot 52 can be otherwise located on any side of the slide end portion 31.

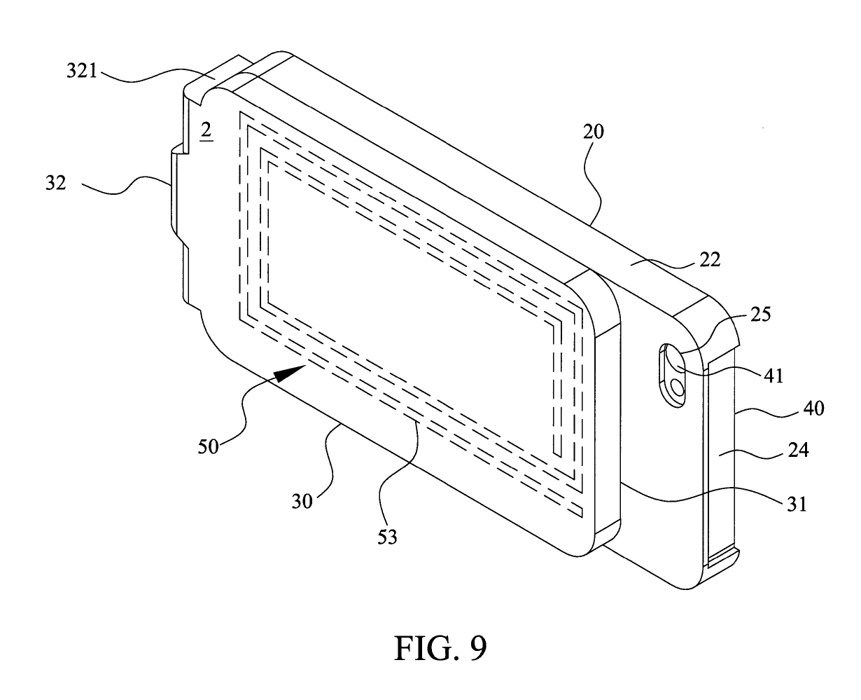

FIG. 9 shows the third preferred embodiment of the present invention, according to which the expansion structure 50 is a transmission antenna 53 embedded in the slide end portion 31 of the functional shell 30 and electrically connected to the connection element 322, so that the hand-held electronic device 40 fitted in the multifunctional protective case 2 can work with an external sensor device (not shown) to achieve near field communication (NFC).

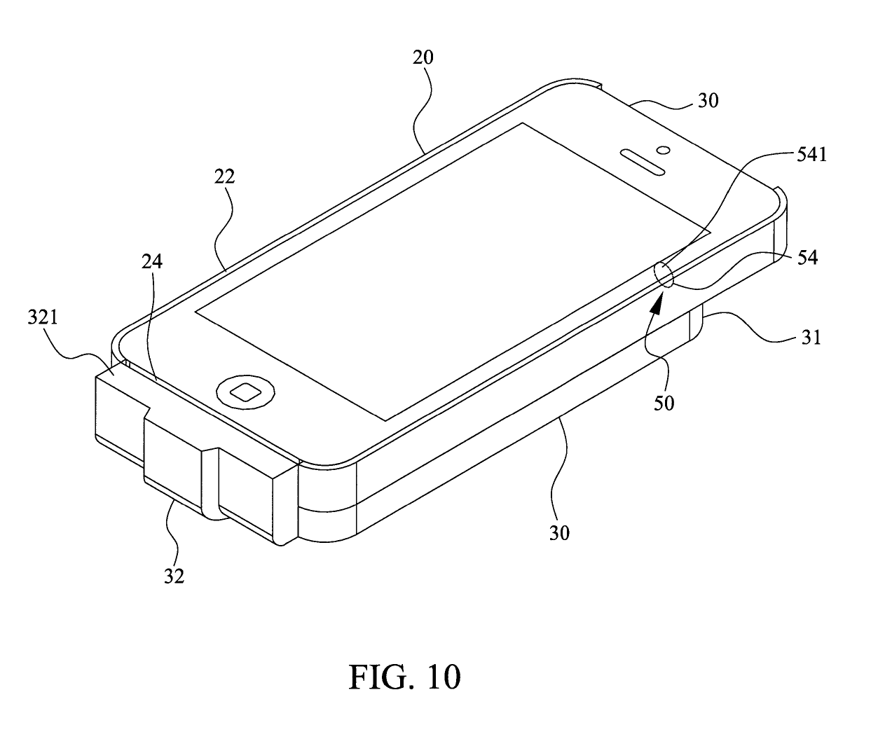

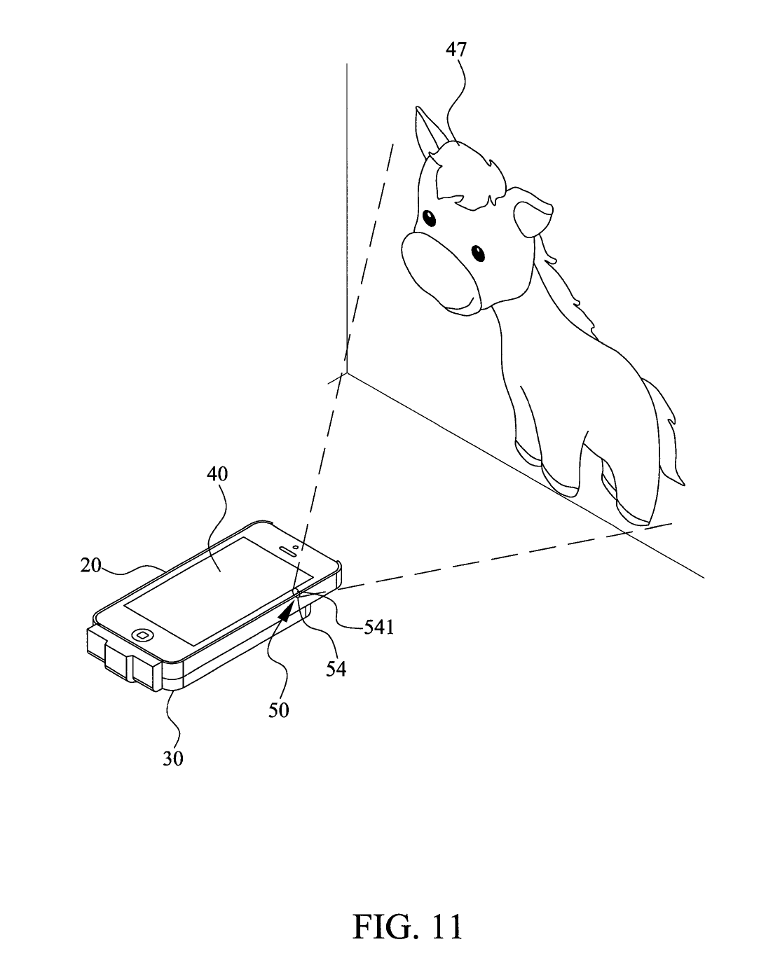

FIG. 10 shows the fourth preferred embodiment of the present invention, according to which the expansion structure 50 is a micro-projector 54 electrically connected to the connection element 322 and accordingly indirectly electrically connected to the hand-held electronic device 40 via the connection element 322. The micro-projector 54 includes a projector lens 541 located on a surface of the functional shell 30. Please refer to FIG. 11. The micro-projector 54 receives images or pictures 47 from the hand-held electronic device 40, and the received images or pictures 47 are projected via the projector lens 541 to present on a planar surface.

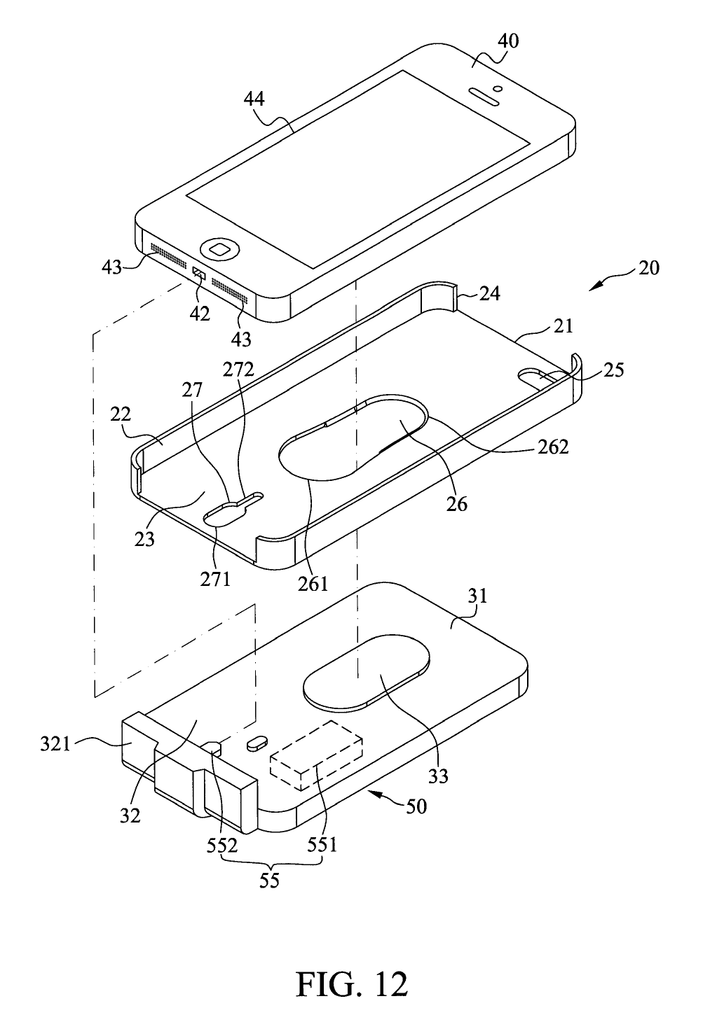

FIG. 12 shows the fifth preferred embodiment of the present invention, according to which the expansion structure 50 is a charging module 55. The charging module 55 includes a power storage unit 551 embedded in the functional shell 30, and a charging and discharging unit 552 located on a surface of the fixing end portion 32 and electrically connected to the power storage unit 551. The power storage unit 551 is selectively used to store power or output power according to actual need.

When the functional shell 30 is assembled to the protective shell 20 with the charging and discharging unit 552 inserted into the transmission jack 42 of the hand-held electronic device 40, the charging and discharging unit 552 is electrically connected to the hand-held electronic device 40. At this point, power stored in the power storage unit 551 can be supplied to the transmission jack 42 via the charging and discharging unit 552 for charging the hand-held electronic device 40. With the expansion structure 50 configured as a charging module 55, the functional shell 30 provides the hand-held electronic device 40 with enhanced power storage capability.

When the power storage unit 551 of the charging module 55 is out of power, simply remove the functional shell 30 from the protective shell 20 and then electrically connect the charging and discharging unit 552 to an external power source (not shown), and power from the external power source can be supplied to the charging and discharging unit 552 to charge the power storage unit 551.

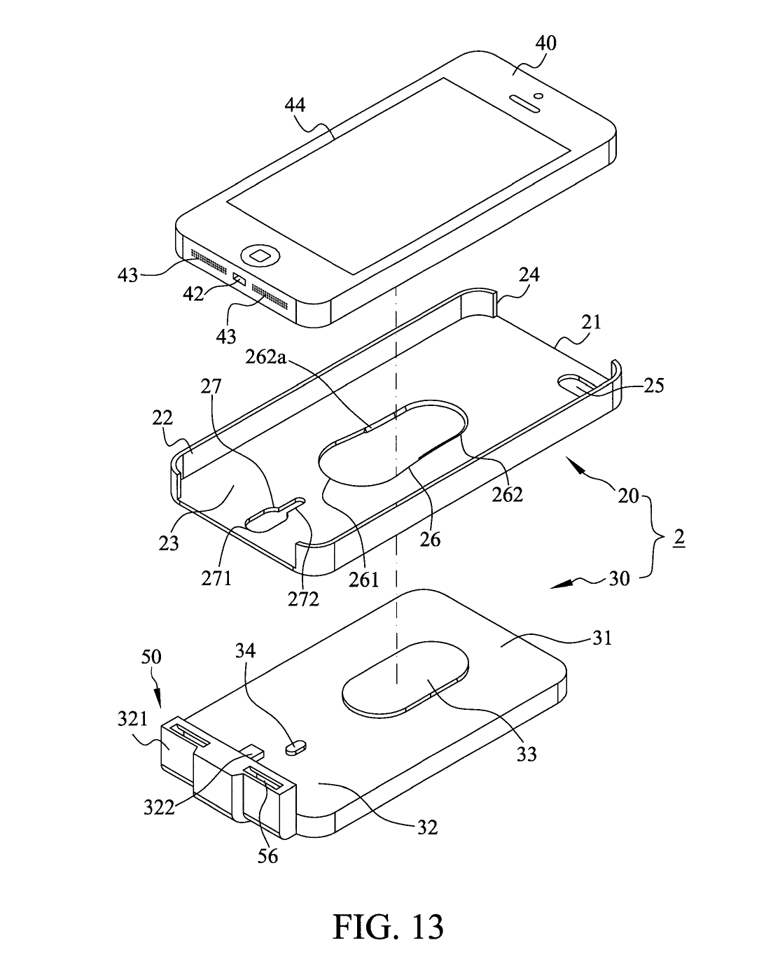

FIG. 13 shows the sixth preferred embodiment of the present invention, according to which the expansion structure 50 is configured as at least one sound guide hole 56 located on the cover plate 321. When the functional shell 30 is assembled to the protective shell 20 that has been fitted onto the hand-held electronic device 40, the sound guide hole 56 has an end located corresponding to the speaker opening 43 on the hand-held electronic device 40 and the connection element 322 is inserted into the transmission jack 42. The sound guide hole 56 has another opposite end located on the cover plate 321 to orient in a direction the same as the display screen 44 of the hand-held electronic device 40.

When the hand-held electronic device 40 plays a sound via the speaker openings 43, the sound guide holes 56 function to concentrate the sound and amplify its volume, enabling the hand-held electronic device 40 to save power and accordingly, have prolonged operating time.

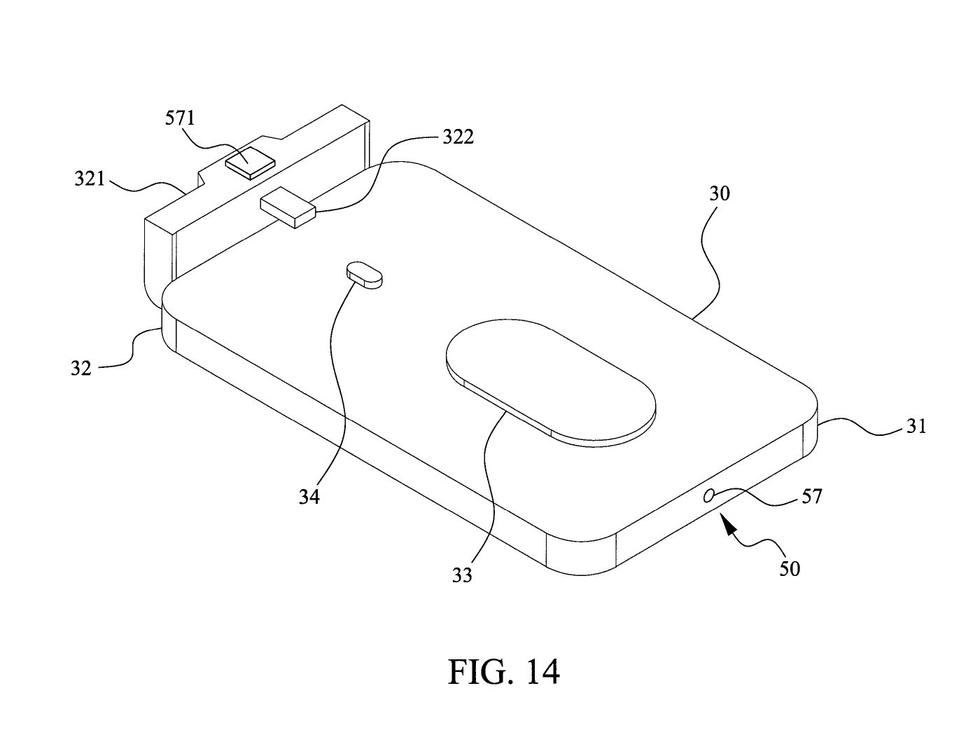

FIG. 14 shows the seventh preferred embodiment of the present invention, according to which the expansion structure 50 includes a light source projector 57 located on a front end surface of the slide end portion 31 of the functional shell 30, and an actuator 571 located on a surface of the fixing end portion 32 of the functional shell 30 and electrically connected to the light source projector 57. According to an operable embodiment, the light source projector 57 is electrically connected to the connection element 322 and powered by the hand-held electronic device 40. According to another operable embodiment, the expansion structure 50 further includes a battery module (not shown) located in the functional shell 30 and electrically connected to the light source projector 57, so that the power needed by the light source projector 57 to operate comes from the battery module instead of the hand-held electronic device 40.

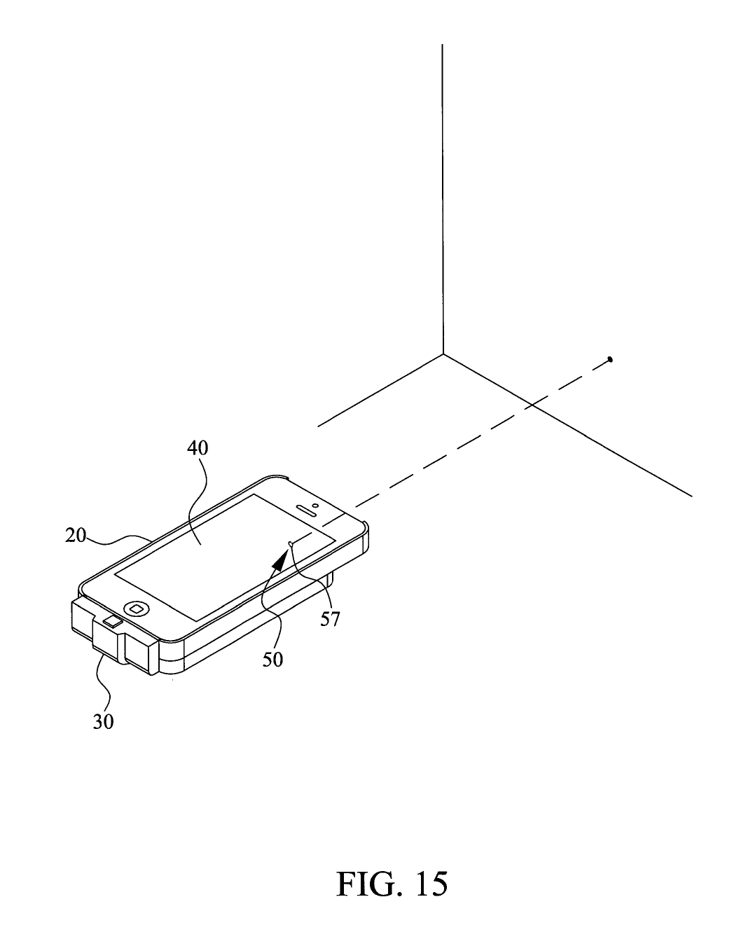

As shown in FIG. 15, the light source projector 57 can be a laser light source for use in a meeting or a briefing to remotely project a laser beam and form a laser light spot on a screen as an indicator. However, it is understood the above description is only illustrative, and the light source projector 57 can be otherwise an ultraviolet light source to serve as a currency detector, or can be other types of light sources for providing different effects or functions.

The light source projector 57 can be directly used with the actuator 571. Alternatively, the light source projector 57 can be directly electrically connected to a transmission module (not shown) that is connected to the hand-held electronic device 40 via wireless communication, so that the light source projector 57 can be controlled via the hand-held electronic device 40 to operate. Or, the transmission module can be connected to an electronic apparatus via a transmission cable, and a user can operate on the electronic apparatus to control the light source projector 57 without the need of providing the actuator 571.

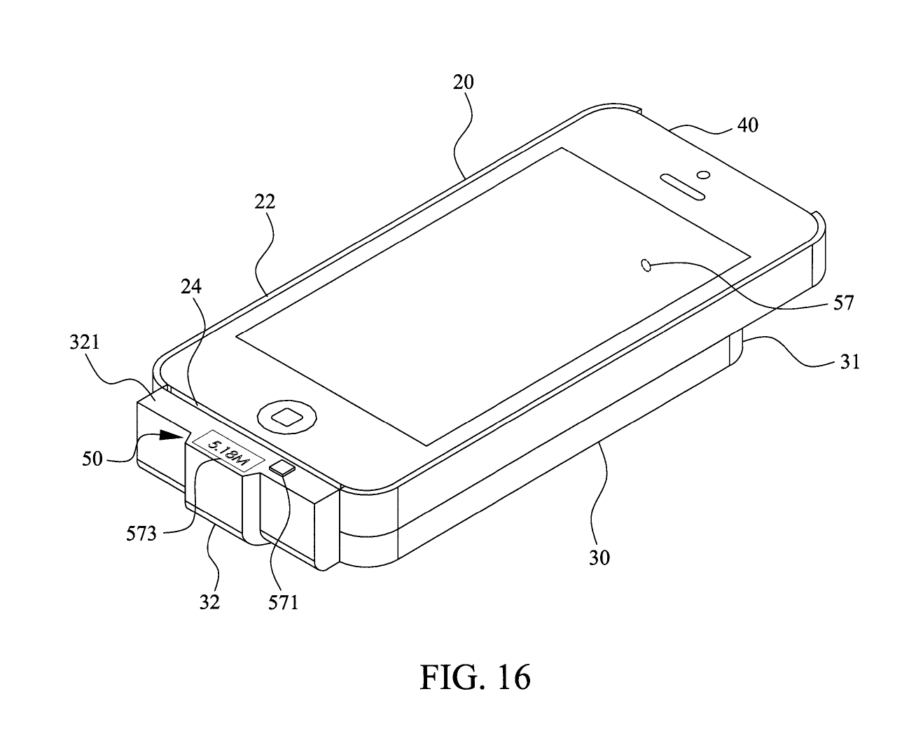

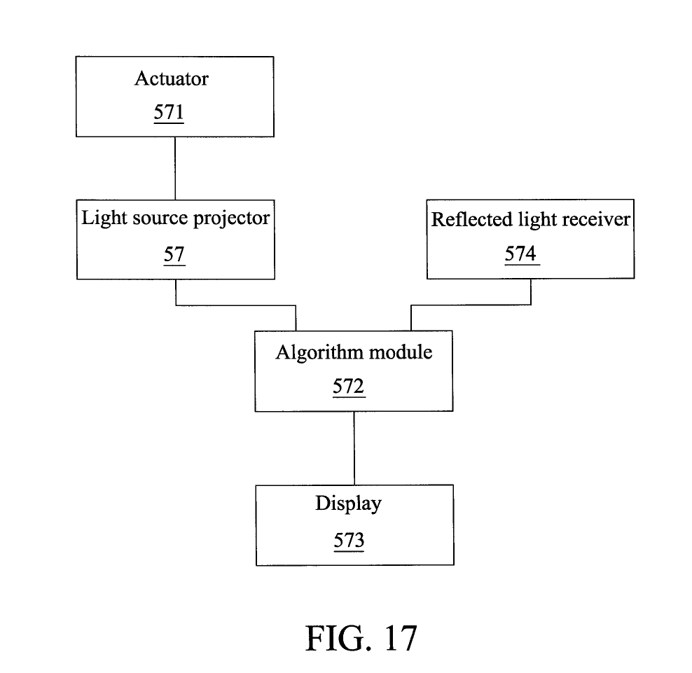

Please refer to FIGS. 16 and 17. The expansion structure 50 for the multifunctional protective case 2 according to the eighth preferred embodiment of the present invention includes a light source projector 57, which is electrically connected not only to an actuator 571, but also to an algorithm module 572. The algorithm module 572 is further electrically connected to a display 573 located on a surface of the functional shell 30 and to a reflected light receiver 574. When the light source projector 57 projects light beams onto a planar surface, the light beams are reflected from the planar surface and received by the reflected light receiver 574. At this point, the algorithm module 572 calculates a distance from the light source projector 57, and data indicating the calculated actual distance is shown on the display 573. Therefore, the expansion structure 50 in the eighth preferred embodiment functions as a laser measurement tool.

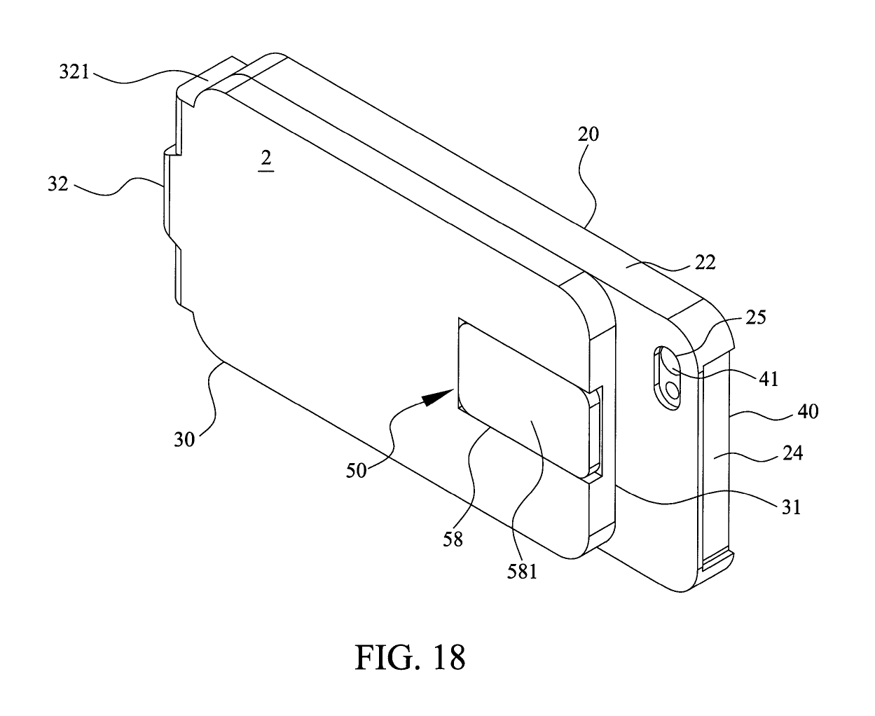

FIG. 18 shows the ninth preferred embodiment of the present invention, according to which the expansion structure 50 includes a retaining slideway 58 formed on an outer side of the functional shell 30, and a remote controller 581 removably retained in the retaining slideway 58. The remote controller 581 is externally provided with at least one control button 581a and internally provided with a wireless transmission module 581b, which is electrically connected to the control button 581a and wirelessly communicable with the hand-held electronic device 40. Therefore, the remote controller 581 and the camera device 41 of the hand-held electronic device 40 together form a means enabling remote camera control. Wherein, the wireless transmission module 581b is wirelessly connected to the hand-held electronic device 40 via WiFi technology or Bluetooth technology.

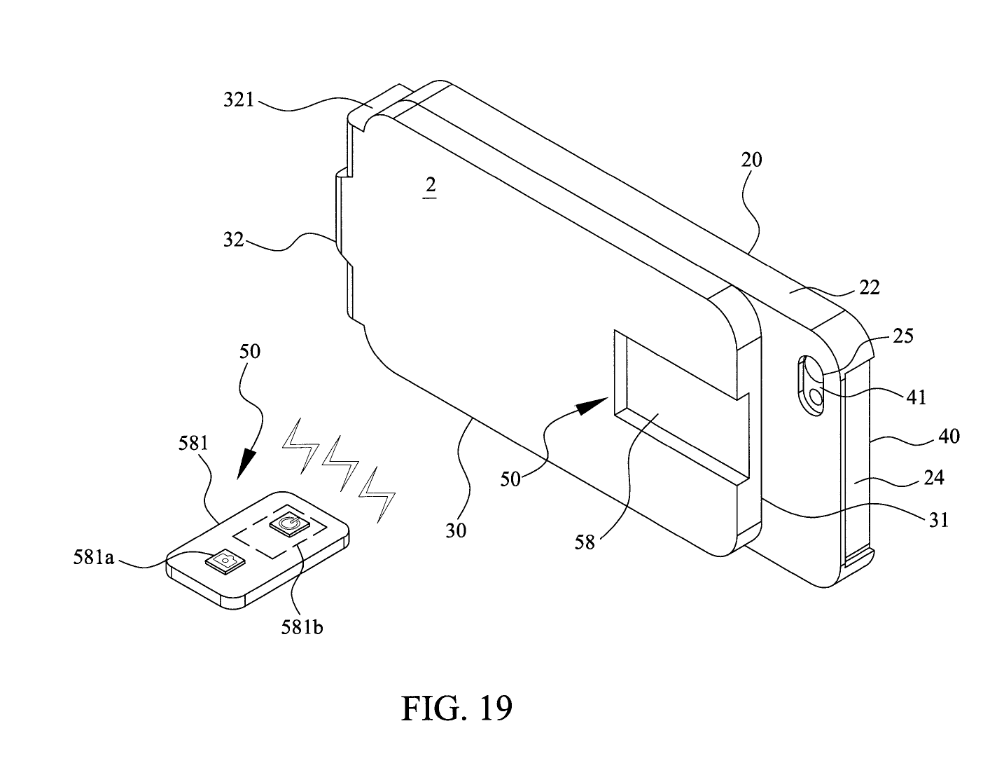

Please refer to FIG. 19. To take pictures with the hand-held electronic device 40 and the expansion structure 50, a user simply removes the remote controller 581 from the retaining slideway 58 and positions the hand-held electronic device 40 at a selected place. The user then goes to a position within the lens shooting angle of the camera device 41 and pushes the control button 581a, and the shooting is completed.

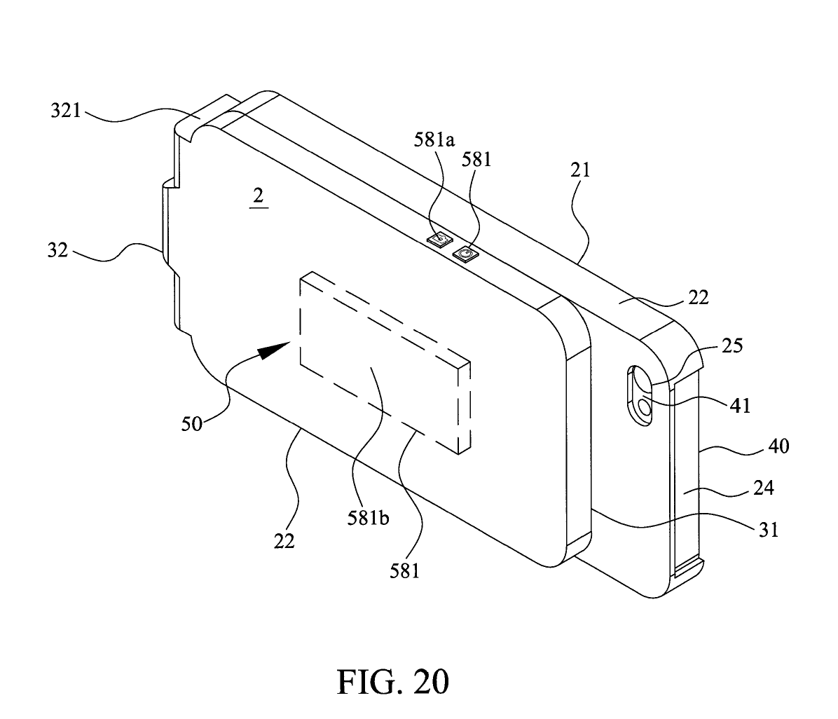

FIG. 20 shows a variant of the expansion structure 50 according to the ninth preferred embodiment of the present invention. In this variant, the remote controller 581 is directly provided on the functional shell 30. The remote controller 581 includes a wireless transmission module 581b embedded in the functional shell 30 and at least one control button 581a provided on a surface of the functional shell 30. The wireless transmission module 581b is electrically connected to the control button 581a and is wirelessly communicable with the hand-held electronic device 40. When a user wants to take a picture, the user needs only to separate the functional shell 30 from the protective shell 20 and then pushes the control button 581a. And, the shooting is completed.

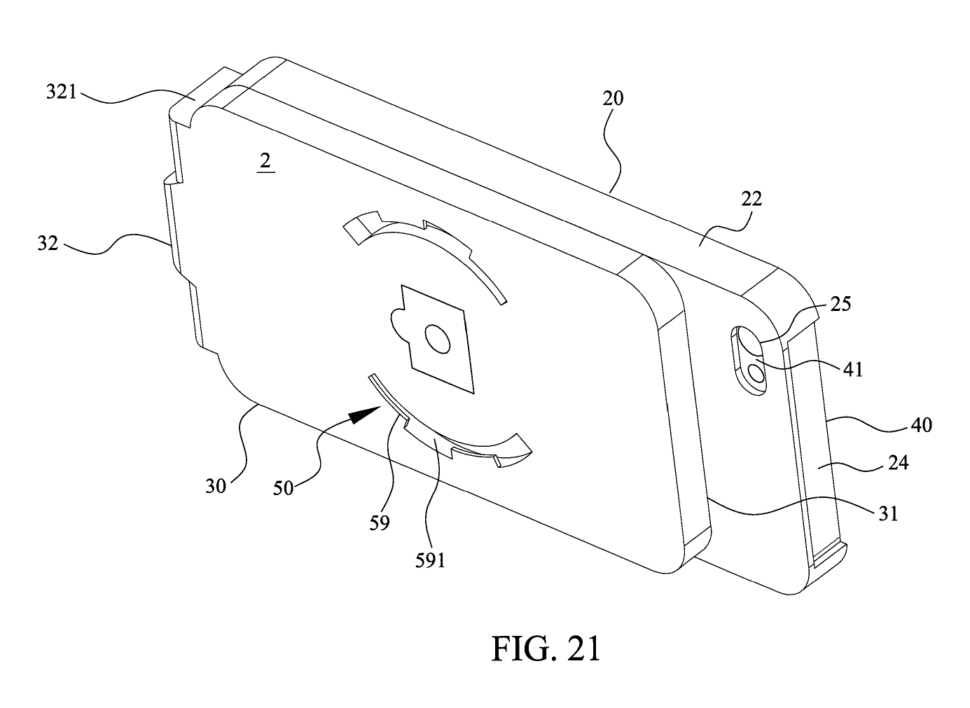

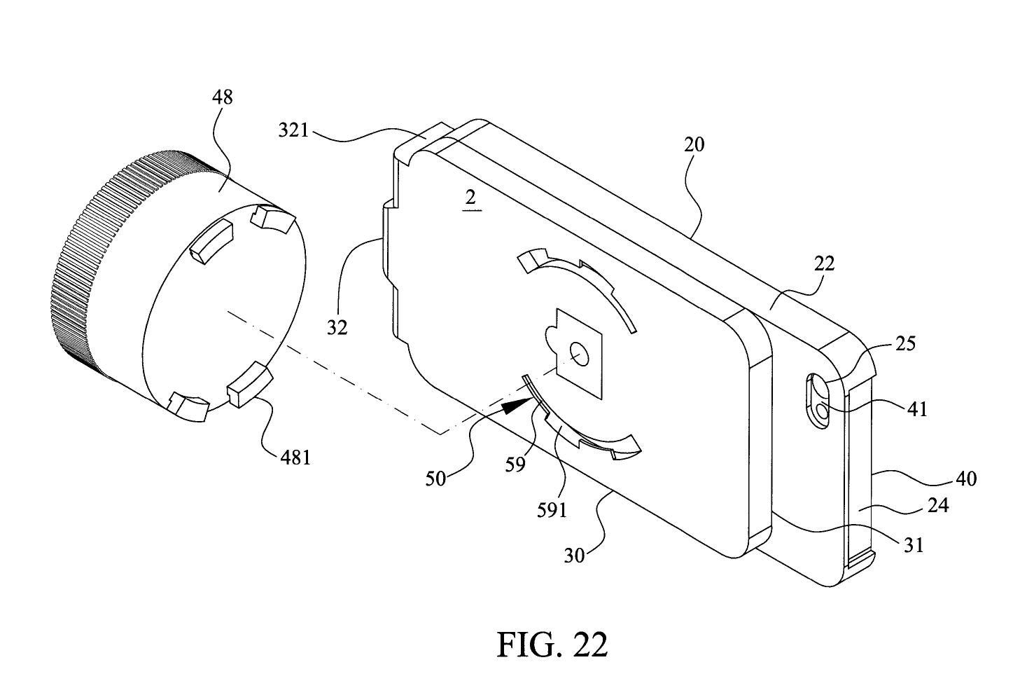

FIG. 21 shows the tenth preferred embodiment of the present invention, according to which the expansion structure 50 is configured as at least one mounting rail 59 formed on an outer side of the slide end portion 31 of the functional shell 30. To the at least one mounting rail 59, a wireless camera lens 48 (see FIG. 22) wirelessly connectable to the hand-held electronic device 40 can be mounted. Therefore, the functional shell 30 forms a lens holder.

Please refer to FIG. 22. The expansion structure 50 illustrated in the tenth preferred embodiment includes two oppositely arranged curved mounting rails 59 which have a common center. The two curved mounting rails 59 respectively have two diametrically expanded fitting sections 591, and the wireless camera lens 48 is provided on a back with four spaced engaging blocks 481 for correspondingly inserting into the four fitting sections 591 of the two mounting rails 59.

To mount the wireless camera lens 48 to the mounting rails 59, first align the engaging blocks 481 with the fitting sections 591, and then turn the wireless camera lens 48 along the curved mounting rails 59 to firmly couple the wireless camera lens 40 with the functional shell 30.

However, it is understood the curved mounting rail 59 is only illustrative and not intended to limit the present invention in any way. For example, in other operable embodiments, the mounting rail 59 can be a straight rail extending in a longitudinal direction, a transverse direction, or an oblique direction on the outer side of the functional shell 30 for fixing the wireless camera lens 48 to different angular position relative to the functional shell 30.

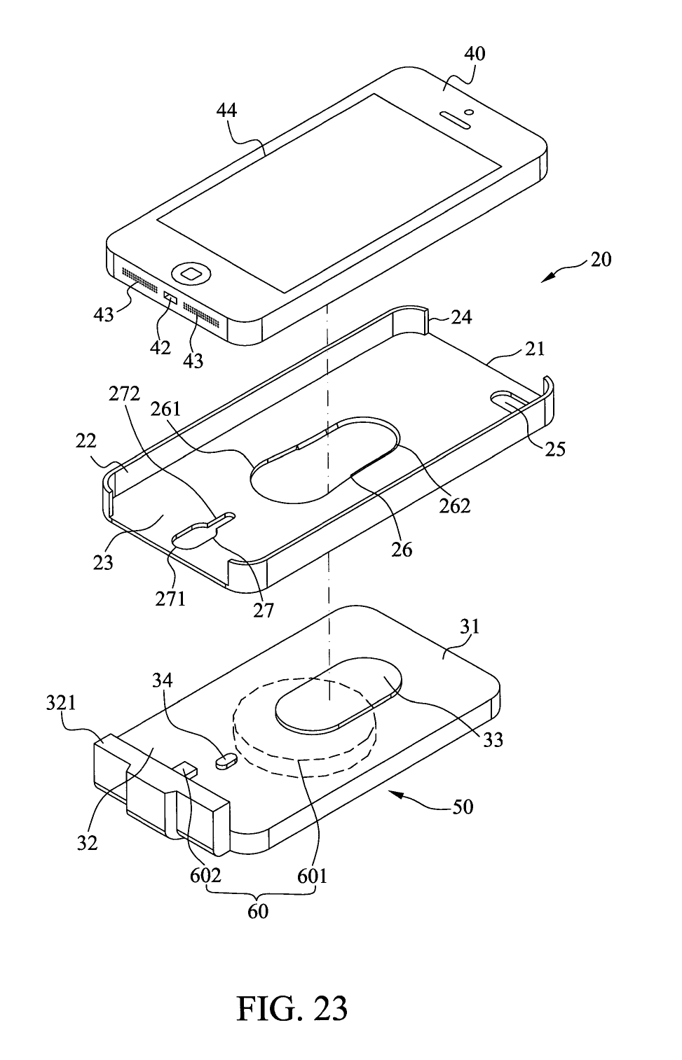

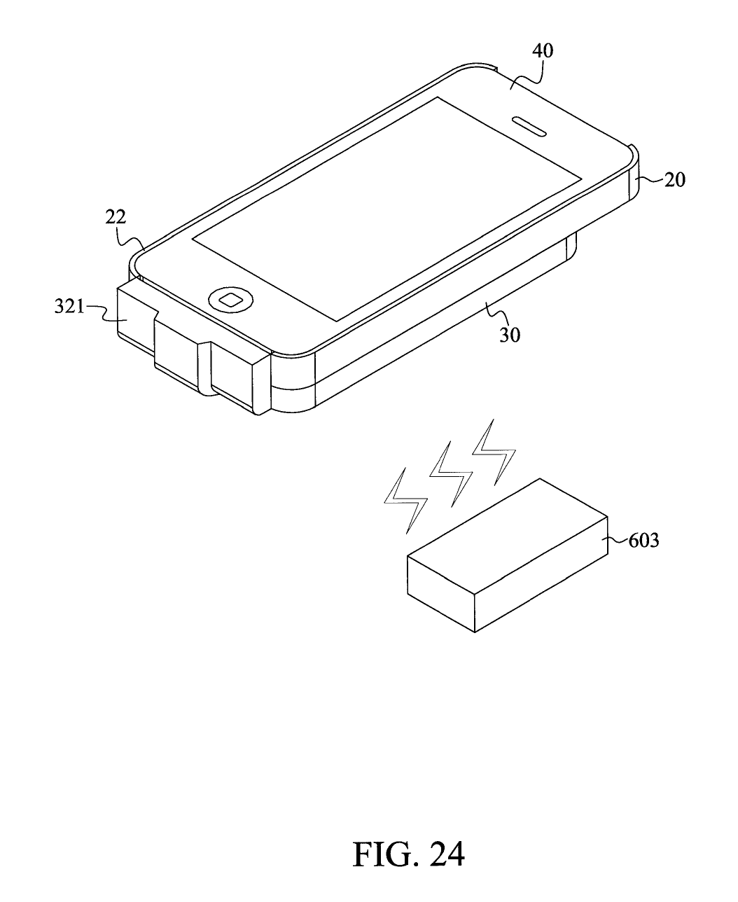

FIGS. 23 and 24 show the eleventh preferred embodiment of the present invention, according to which the expansion structure 50 is a wireless charging module 60. The wireless charging module 60 includes a wireless charging receiver unit 601 embedded in the functional shell 30, and a connection terminal 602 located on a surface of the fixing end portion 32. The wireless charging receiver unit 601 functions to receive an electric energy signal from an external wireless charging transmitter unit 603, and the connection terminal 602 is electrically connected to both of the wireless charging receiver unit 601 and the hand-held electronic device 40.

To use the eleventh preferred embodiment of the present invention, first assemble the functional shell 30 to the protective shell 20 for the wireless charging receiver unit 601 to locate below the hand-held electronic device 40. Then, approach the hand-held electronic device 40 and the multifunctional protective case 2 fitted thereon to the external wireless charging transmitter unit 603. In this way, the external wireless charging transmitter unit 603 can wirelessly transmit the electric energy stored therein to the wireless charging receiver unit 601, which in turn uses the received electric energy signal to charge the hand-held electronic device 40 via the connection terminal 602. Therefore, the expansion structure 50 in the eleventh preferred embodiment of the present invention provides a wireless charging means.

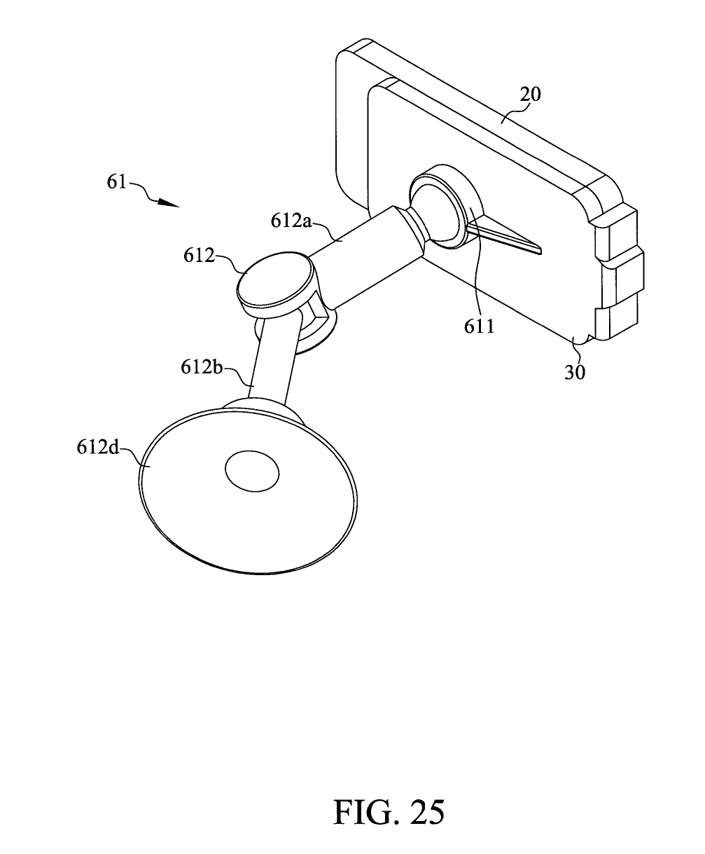

FIG. 25 shows the twelfth preferred embodiment of the present invention, according to which the expansion structure 50 is a stand structure 61 connected to the outer side of the functional shell 30. The stand structure 61 includes a coupling seat 611 protruded from the outer side of the functional shell 30, and a supporting arm 612 rotatably coupled with the coupling seat 611.

As shown, the supporting arm 612 includes a first connection bar 612a and a second connection bar 612b. The first connection bar 612a is rotatably connected at a first end to the coupling seat 611 on the functional shell 30, and at an opposite second end to a first end of the second connection bar 612b, so that an included angle between the first connection bar 612a and the second connection bar 612b can be selectively adjusted.

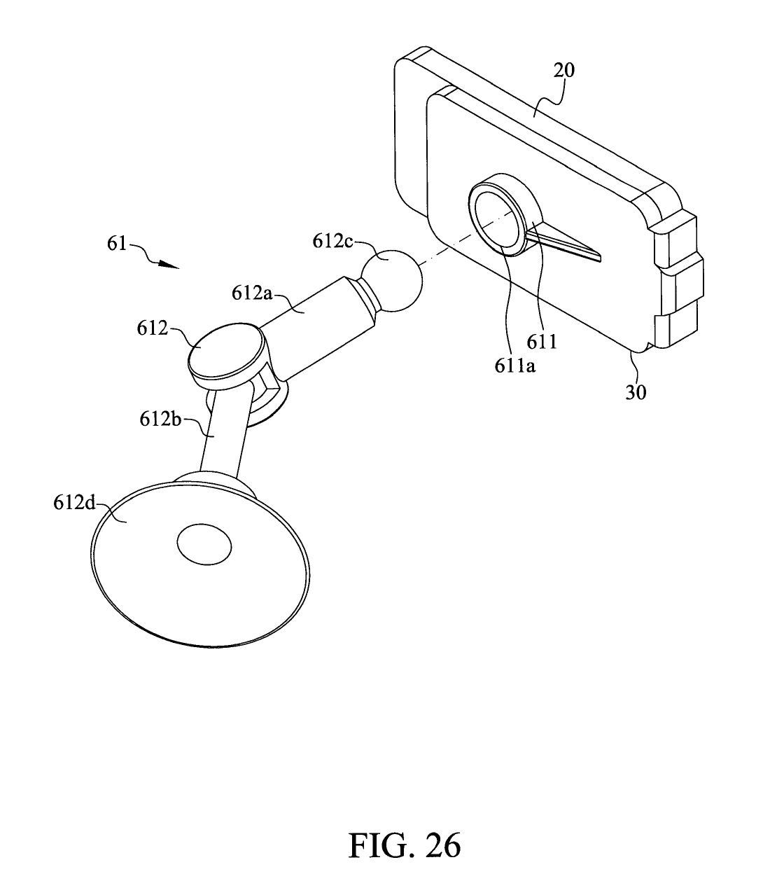

Please refer to FIG. 26. The coupling seat 611 includes a clamping socket 611a, and the first connection bar 612a is correspondingly provided at the first end thereof with a ball 612c. The ball 612c is rotatably coupled with the clamping socket 611a, such that the first connection bar 612a and the functional shell 30 can swivel relative to each other. Further, the second connection bar 612b is provided at an opposite second end thereof with a suction cup 612d capable of fixedly attaching to a smooth surface. In other operable embodiments, depending on different use environments, an adhesive element, a hooking element or a snap-fastening element can be used to replace the suction cup 612d.

To use the expansion structure 50 according to the twelfth preferred embodiment of the present invention, first attach the suction cup 612d of the second connection bar 612b to a smooth surface in the use environment, and then adjust the included angle between the first connection bar 612a and the second connection bar 612b, as well as the angular position of the first connection bar 612a relative to the functional shell 30, so that the hand-held electronic device 40 is located in an angular position most suitable for the user to operate the hand-held electronic device 40 in a convenient manner.

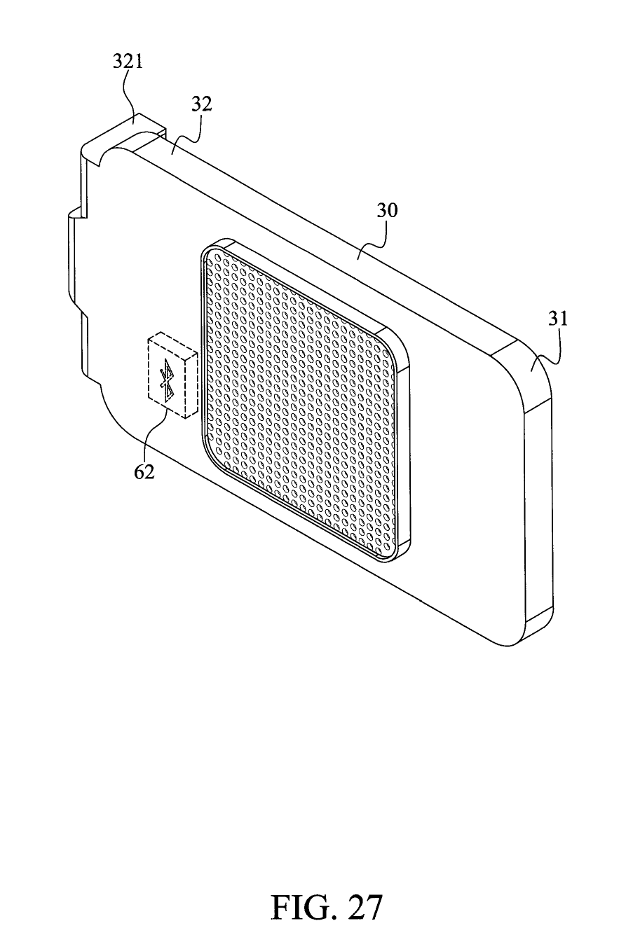

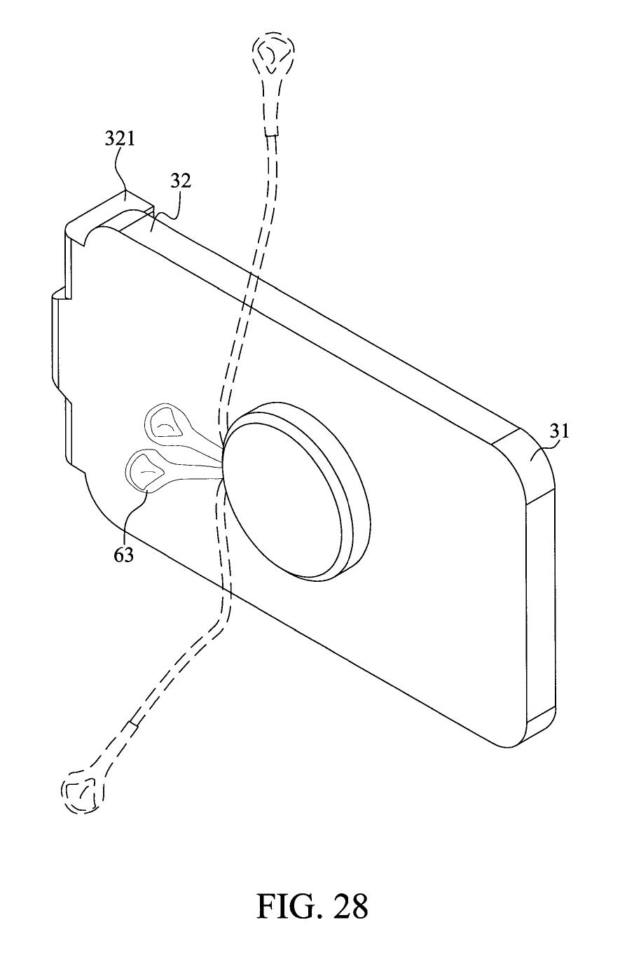

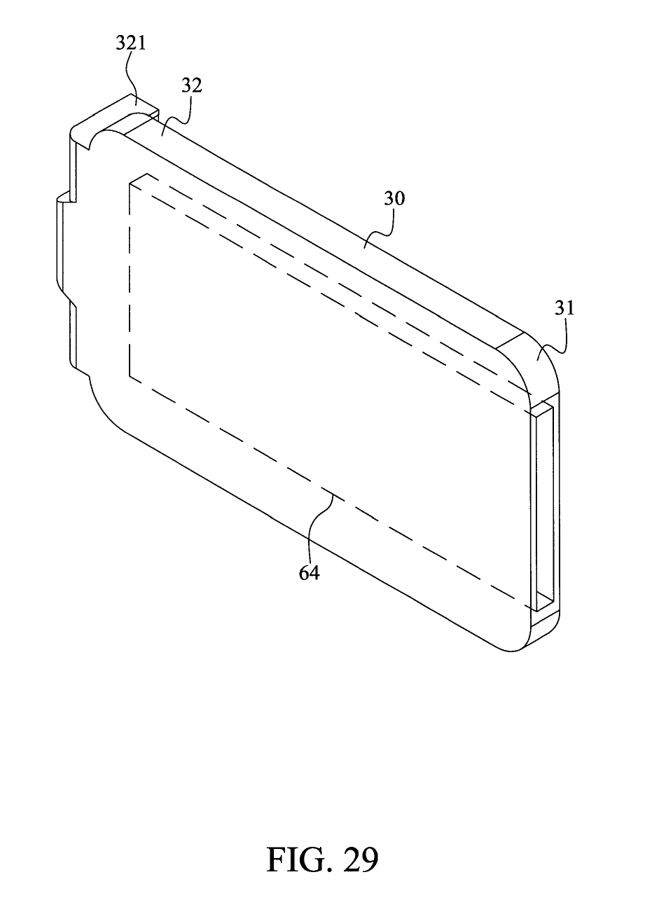

It is understood all the above-described configurations for the expansion structure 50 are only illustrative and not intended to limit the expansion structure 50 in any way. For example, in still some other operable embodiments, the expansion structure 50 can be a Bluetooth stereo device 62 as shown in FIG. 27, or an earphone cord organizer 63 as shown in FIG. 28, or an organizing device 64 as shown in FIG. 29, so as to provide different functions.

While the above preferred embodiments of the multifunctional protective case 2 according to the present invention respectively have the expansion structure 50 with single function, it is understood one of ordinary skill in the art can be taught by the present invention to integrate two or more different functions into the expansion structure 50 of the same one functional shell 30, enabling the functional shell 30 to provide two or more different functions and accordingly largely upgrade the overall utilization of the protective case for electronic device.

In conclusion, the multifunctional protective case for electronic device according to the present invention is assembled from two different parts. One of the parts is a protective shell serving as a protection layer for normally fitting on the electronic device, and the other part is an exchangeable functional shell having an expansion structure with one or more specific functions. Therefore, a user can, depending on actual need in use, select one functional shell that has an expansion structure with the desired function or functions, and removably assembles the selected functional shell to the protective shell. And, the functional shell can be freely replaced with another one that provides a different expanded function. Thus, the protective case can have largely increased functionality. Further, the functional shell is slidably retained to the protective shell, enabling the two shells to be quickly assembled to or disassembled from each other. Thus, the multifunctional protective case of the present invention is more convenient and more practical for use.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A multifunctional protective case for electronic device, the electronic device being a hand-held electronic device, and the multifunctional protective case comprising:
a protective shell including a base having two opposite inner and outer sides, and a plurality of retaining sections upward extended from outer edges of the base, such that a locating space is defined between the base and the retaining sections for holding the hand-held electronic device therein; and the base further having a slideway formed thereon; and
a functional shell adjoining the outer side of the base, and including a slide end portion for detachably held to the protective shell and a fixing end portion for fixing to one of the hand-held electronic device and the protective shell; the functional shell being provided with at least one expansion structure that provides at least one specific function; and the slide end portion having a slide block formed thereon for movably setting in the slideway on the base of the protective shell;
whereby, through detachable engagement with the slide end portion and the fixing end portion, the protective shell is selectively assembled to or disassembled from the functional shell, and a user can, according to actual need in use, replace an originally assembled functional shell with another one that has an expansion structure providing other different functions.

2. The multifunctional protective case for electronic device as claimed in claim 1, wherein the base of the protective shell is further formed with an auxiliary locating rail, and the slide end portion of the functional shell further having a guide block formed thereon for movably setting in the auxiliary locating rail.

3. The multifunctional protective case for electronic device as claimed in claim 1, wherein the slideway is configured as a through hole and includes a wider insetting section and a narrower limiting section; the slide block being upwardly set into the slideway via the insetting section and then moved into the limiting section; and the limiting section being provided along two lateral edges thereof with two lengths of limiting projections while the slide block being provided along two lateral edges thereof with two lengths of limiting grooves for correspondingly engaging with the limiting projections, so as to limit the slide block to slide horizontally in the limiting section.

4. The multifunctional protective case for electronic device as claimed in claim 1, wherein the protective shell includes an opening formed between the retaining sections, and the functional shell includes a cover plate formed at the fixing end portion corresponding to the opening; and the cover plate being provided with a connection element for connecting to the hand-held electronic device when the functional shell is assembled to the protective shell.

5. The multifunctional protective case for electronic device as claimed in claim 4, wherein the expansion structure includes a magnetic connector electrically connected to the connection element; the magnetic connector including an electric contact for contacting with and accordingly electrically connecting to an external transmission cable, and a plurality of magnetic elements located nearby the electric contact; whereby the magnetic connector and the external transmission cable can be quickly connected to each other through magnetic attachment of the magnetic elements on the magnetic connector to magnetic elements corresponding provided on the external transmission cable.

6. The multifunctional protective case for electronic device as claimed in claim 4, wherein the expansion structure includes a slot electrically connected to the connection element and for a memory card to insert therein; and the slot being indirectly electrically connected to the hand-held electronic device via the connection element.

7. The multifunctional protective case for electronic device as claimed in claim 4, wherein the expansion structure includes a transmission antenna embedded in the functional shell and electrically connected to the connection element; and the transmission antenna being workable with an external sensor device to form a near field communication means.

8. The multifunctional protective case for electronic device as claimed in claim 4, wherein the expansion structure includes a micro-projector electrically connected to the connection element; and the micro-projector being indirectly electrically connected to the hand-held electronic device via the connection element and including a projector lens located on a surface of the functional shell.

9. The multifunctional protective case for electronic device as claimed in claim 1, wherein the expansion structure includes a charging module; the charging module including a power storage unit embedded in the functional shell, and a charging and discharging unit located on a surface of the fixing end portion and electrically connected to both of the power storage unit and the hand-held electronic device.

10. The multifunctional protective case for electronic device as claimed in claim 4, wherein the hand-held electronic device includes at least one speaker opening and a display screen, and the expansion structure includes at least one sound guide hole located on the cover plate; and the sound guide hole having an end facing to and located adjacent to the speaker opening on the hand-held electronic device and another opposite end oriented in a direction the same as the display screen of the hand-held electronic device.

11. The multifunctional protective case for electronic device as claimed in claim 1, wherein the expansion structure includes a light source projector located on a surface of the functional shell, and an actuator also located on a surface of the functional shell and electrically connected to the light source projector.

12. The multifunctional protective case for electronic device as claimed in claim 11, wherein the expansion structure further includes a reflected light receiver and an algorithm module; and the algorithm module being electrically connected to the light source projector and the reflected light receiver, as well as to a display provided on a surface of the functional shell.

13. The multifunctional protective case for electronic device as claimed in claim 1, wherein the expansion structure includes a retaining slideway formed on an outer side of the functional shell, and a remote controller removably retained in the retaining slideway; the remote controller being externally provided with at least one control button and internally provided with a wireless transmission module; and the wireless transmission module being electrically connected to the control button and wirelessly communicable with the hand-held electronic device.

14. The multifunctional protective case for electronic device as claimed in claim 1, wherein the expansion structure includes a wireless transmission module embedded in the functional shell and at least one control button located on a surface of the functional shell; and the wireless transmission module being electrically connected to the control button and wirelessly communicable with the hand-held electronic device.

15. The multifunctional protective case for electronic device as claimed in claim 1, wherein the expansion module includes at least one mounting rail for a wireless camera lens to mount thereto, and the wireless camera lens being provided with at least one engaging block for correspondingly inserting into the mounting rail.

16. The multifunctional protective case for electronic device as claimed in claim 1, wherein the expansion structure includes a wireless charging module; the wireless charging module including a wireless charging receiver unit embedded in the functional shell and a connection terminal located on a surface of the fixing end portion of the functional shell; the wireless charging receiver unit receiving a signal from an external wireless charging transmitter unit; and the connection terminal being electrically connected to the wireless charging receiver unit and the hand-held electronic device.

17. The multifunctional protective case for electronic device as claimed in claim 1, wherein the expansion structure includes a stand structure connected to an outer side of the functional shell; and the stand structure including a coupling seat protruded from the outer side of the functional shell and a supporting arm rotatably coupled with the coupling seat.

18. The multifunctional protective case for electronic device as claimed in claim 17, wherein the supporting arm is provided at an end with a suction cup for attaching to a smooth surface and at another opposite end with a ball, and the coupling seat located on the functional shell includes a clamping socket corresponding to the ball; wherein the ball is rotatably coupled with the clamping socket, allowing the functional shell and the supporting arm to swivel relative to each other.

19. The multifunctional protective case for electronic device as claimed in claim 18, wherein the supporting arm includes a first connection bar and a second connection bar, which are rotatably connected end to end, so that an included angle between the first connection bar and the second connection bar is adjustable; and the ball being located at an end of the first connection bar facing away from the second connection bar, and the suction cup being located at an end of the second connection bar facing away from the first connection bar.
